(19) United States
(12) Patent Application Publication
(10) Pub. No.: US 2002/0049731 A1
(43) Pub. Date: Apr. 25, 2002

(54) Information processing method and apparatus

(76) Inventor: Takuya Kotani, Kanagawa (JP)

Correspondence Address: ROBIN BLECKER & DALEY, 2ND FLOOR, 330 MADISON AVENUE, NEW YORK, NY, 10017, US

(21) Appl. No.: 09/867,737

(22) Filed: May 30, 2001

(30) Foreign Application Priority Data
May 31, 2000 (JP) 2000-163373
May 7, 2001 (JP) 2001-136556

(51) Int. Cl. G06F 7/00

(52) U.S. Cl. 707/1

(57) ABSTRACT

When binary data and metadata related to the binary data are stored into a storage medium, a metadata storage area is allocated in advance on the storage medium. Then a storage area is allocated for storing the metadata from the head of the metadata storage area, and the metadata is stored into the allocated area. On the other hand, the binary data related to the metadata is stored into a general area other than the metadata storage area. Then link information which links the metadata and the binary data is written, in correspondence with the metadata, into the metadata storage area. As all the metadata are stored in the specialized storage area, the metadata attached to the binary data can be accessed at a high speed.

### FIELD OF THE INVENTION

The present invention relates to management of metadata to be attached to binary data, and more particularly, to information processing method and apparatus which enable high-speed access to metadata.

### BACKGROUND OF THE INVENTION

Metadata is “data on data” used as explanation of binary data such as image data and sound data. A search for image data, sound data and the like can be made by metadata set for respective binary data. Now the usefulness of the metadata is widely known. Various forms of metadata are prepared for binary data, and attempts to utilize them in searching by using data base are made.

As binary data search methods, a method of generating data base related to binary data as search subjects and a method of performing a search by reading metadata at whatever time are known. In the former case, a search can be made at a high speed when an enormous number of search subject data are prepared. However, the method cannot easily handle changes in situation due to addition and/or deletion of binary data. Accordingly, further proposed is a method having flexibly to changes in situation due to addition and/or deletion of binary data by describing binary data and metadata in the same file and using the latter search method.

However, in the method of describing binary data and metadata in the same file, when an enormous amount of search subject data are provided, the speed of search processing is extremely lowered since a search must be made by reading files each including binary data and metadata and extracting the metadata. Especially, when a search is made for binary data stored in a storage -medium with a low access speed such as a magneto-optic disk (MO), the speed of search processing is seriously reduced.

### SUMMARY OF THE INVENTION

The present invention has been made in consideration of the above problems, and has its object to enable high-speed access to metadata of binary data as a search subject.

Further, in case of metadata of independent-format binary data, significant data cannot be extracted unless the data is read in accordance with the format. Accordingly, another object of the present invention is to solve the problem and enable flexible access to internal data by using metadata described in highly versatile data description language.

According to the present invention, the foregoing object is attained by providing an information processing method for storing binary data and metadata related to binary data into a storage medium, comprising an allocation step of allocating a first storage area for metadata in advance on the storage medium, a first storage step of allocating a metadata storage area for storing metadata from the first storage area allocated at the allocation step, and storing metadata into the metadata storage area, a second storage step of storing binary data related to metadata into a second storage area other than the first storage area on the storage medium, and a third storage step of storing link information that links metadata stored in the first storage area with binary data stored in the second storage area, in correspondence with metadata, into the first storage area, wherein at third storage step, the link information is stored into an area adjacent to an area where metadata is stored.

Further, the foregoing object is attained by providing an information processing apparatus for storing binary data and metadata related to the binary data into a storage medium, comprising allocation means for allocating a first storage area for metadata in advance on the storage medium, first storage means for allocating a metadata storage area for storing metadata from the first storage area allocated by the allocation means, and storing metadata into the metadata storage area, second storage means storing binary data related to metadata into a second storage area other than the first storage area on the storage medium, and third storage means for storing link information that links metadata stored in the first storage area with binary data stored in the second storage area, in correspondence with metadata, into the first storage area, wherein the third storage means stores the link information into an area adjacent to an area where metadata is stored.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of system configuration according to a first embodiment of the present invention;

FIG. 2 is a schematic diagram showing the structure of binary data with metadata and form of data storage into a storage medium;

FIG. 3 is a table showing an example of metadata managed in accordance with the first embodiment;

FIG. 4 is an example of XML description of the metadata in FIG. 3;

FIG. 5 is a perspective view explaining a metadata storage area according to the first embodiment;

FIG. 6 is a schematic diagram showing the storage area of a disk when a metadata storage area is allocated by generating an area file;

FIG. 7 is a flowchart showing file storage processing according to the first embodiment;

FIG. 8 is a flowchart showing processing to allocate an area for storing metadata from the metadata storage area and store the metadata into the area;

FIG. 9 is a flowchart showing processing to establish linkage between binary data and metadata;

FIG. 10 is a schematic view explaining the status of file stored in the storage medium according to the first embodiment; and

FIG. 11 is an example of metadata description according to a third embodiment of the present invention.

### DETAILED DESCRIPTION OF THE PREFERRED EMBODIMENTS

Preferred embodiments of the present invention will now be described in detail in accordance with the accompanying drawings.

<First Embodiment>

As a first embodiment, information processing apparatus and method for high-speed access to metadata in a case where binary data and metadata are stored in the same file will be described.

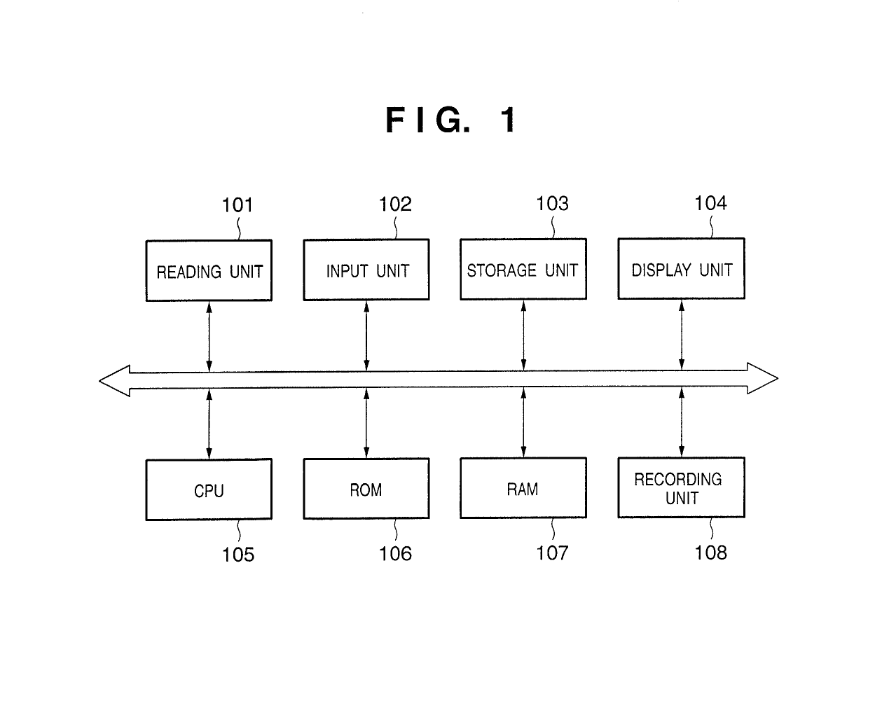

FIG. 1 is a block diagram showing an example of system configuration according to the first embodiment. In FIG. 1, a data reading unit 101 which reads data includes devices such as a scanner. A data input unit 102 which inputs an instruction from a user or data includes pointing devices such as a keyboard and a mouse. A storage unit 103, which is a device for storing a control program and the like, is generally a hard disk or the like. A display unit 104, which displays a GUI image and the like, is generally a CRT, or a liquid crystal display.

A CPU 105 relates to all the processings in the above elements. A ROM 106 and a RAM 107 provide a program, data, a work area and the like necessary for processing to the CPU 105. Further, a control programs necessary for all the processings is stored in the storage unit 103 or the ROM 106. In a case where the control program to be executed is stored in the storage unit 103, the program is temporarily read (loaded) onto the RAM 107 and then executed by the CPU 105. A recording unit 108, which is a device for storing binary data and metadata, is an MO, DVD-RAM or the like.

Regarding the system configuration, various constituent elements other than the above elements may be provided and various modifications may be made to the system, however, such matter is not the principal object of the present invention, therefore the explanation thereof will be omitted.

Hereinbelow, first, the structure of file in which binary data and metadata are stored will be described, then a metadata storage area in which the metadata is stored will be described, then processing to acquire the metadata storage area will be described, and finally, processing to save the file where the binary data and the metadata are stored will be described.

(File Structure)

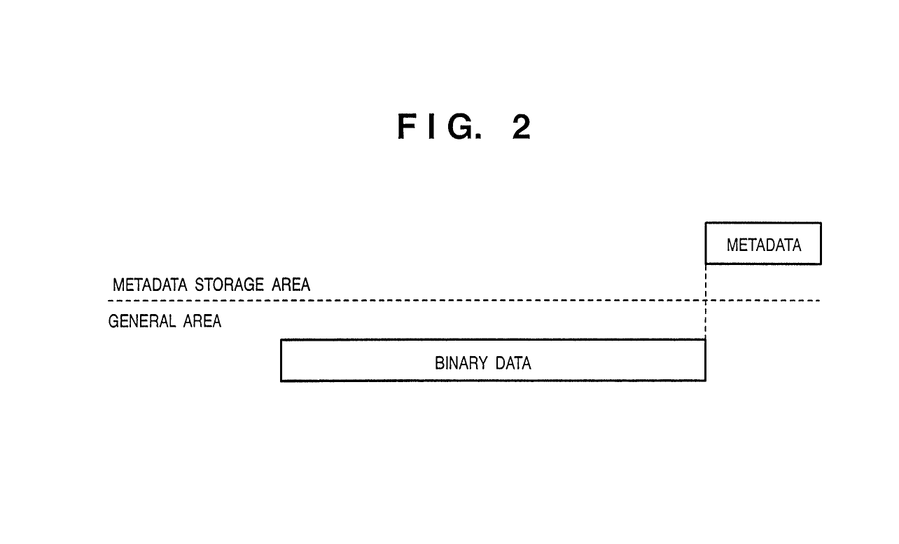

FIG. 2 is a schematic diagram showing the structure of binary data with metadata and form of data storage into a storage medium. In the present embodiment, binary data is a still image data in DCF (Design Rule for Camera File System)(a unified digital camera general recording format) basic file format. In FIG. 2, the binary data and the metadata construct one file, however, they are stored in different areas on a storage medium corresponding to the recording unit 108 in FIG. 1. That is, the metadata is stored into a storage area for metadata (hereinbelow, metadata storage area), while the binary data is stored into an area other than the metadata storage area (hereinbelow, general area). Further, as a file structure, metadata is attached to the end of binary data. In this manner, as a binary file and metadata are stored as the same file, linkage can be easily made between the binary file and the metadata upon file movement or deletion.

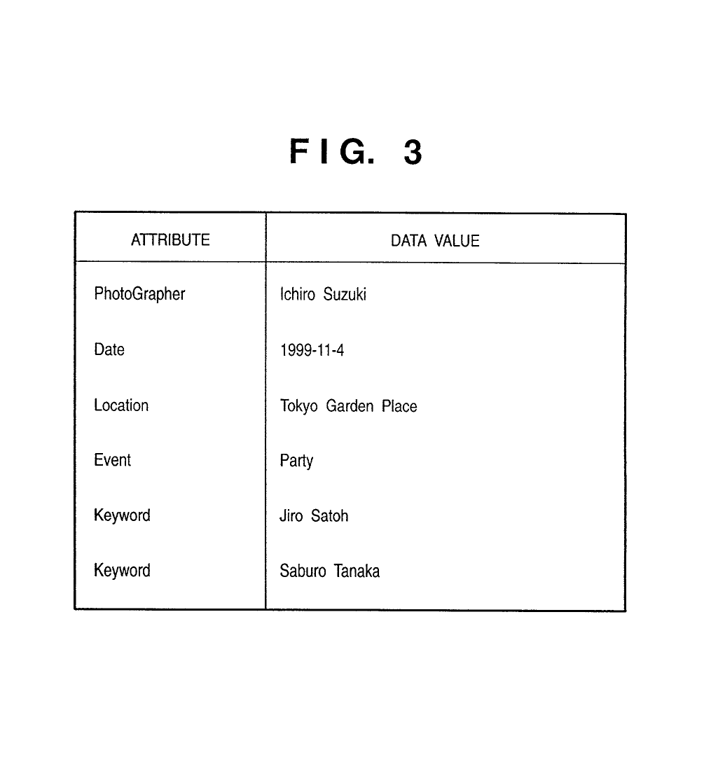

FIG. 3 is a table showing an example of metadata managed in accordance with the first embodiment. The table shows metadata attached to still image binary data. As a format of metadata attached to a still image, expression of pair of data attribute and data value as shown in FIG. 3 can be given.

In the example of FIG. 3, five attributes of metadata, “PhotoGrapher”, “Date”, “Location”, “Event”, “Keyword” are shown, and as respective data values, the name of photographer is described for the attribute “PhotoGrapher”; the date of photo shooting, for the attribute “Date”; the location of photo shooting, for the attribute “Location”; the name of event, for the attribute “Event”; and the name of subject, for the attribute “Keyword”.

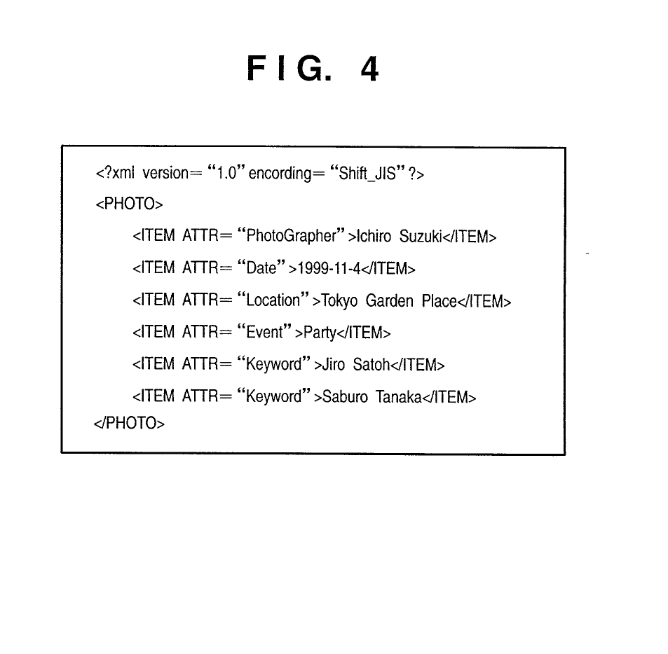

Metadata may be stored as text data, however, in the present embodiment, the stored metadata is described in data description language XML. FIG. 4 is an example of XML description of metadata in FIG. 3. First, a tag representing the start of XML is described, then a tag representing the metadata is described. For example, in the present embodiment, data described by enclosing the metadata in FIG. 3 with a start tag <PHOTO> and an end tag </PHOTO> is metadata. Further, in the present embodiment, in each metadata, attribute str1 and data str2 are described as

<ITEM ATTR=“strl”>str2 </ITEM>.

By this metadata description in XML, highly flexible data description can be made.

(Metadata Storage Area)

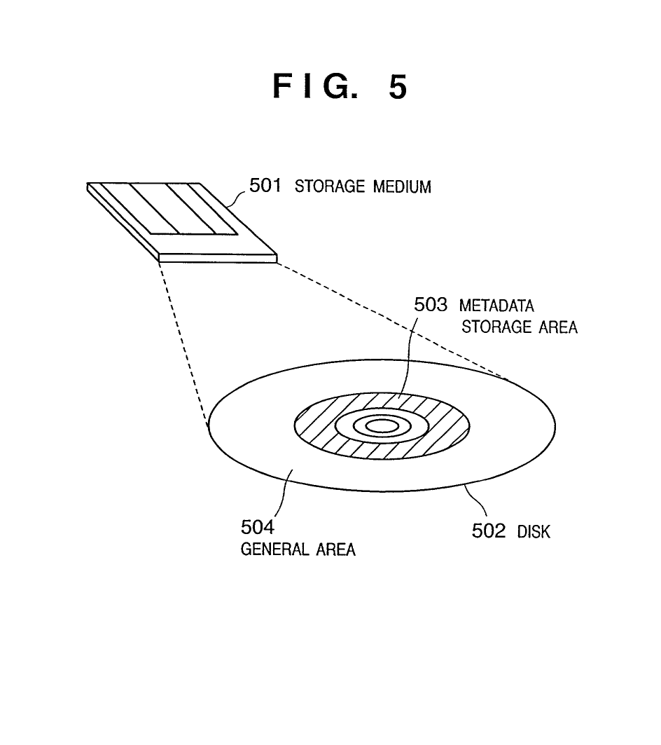

FIG. 5 is a perspective view explaining a metadata storage area according to the first embodiment. In the present embodiment, a storage medium corresponding to the recording unit 108 is an MO, and a logical format of MO disk is UDF (Universal Disk Format). In use of UDF file management system, file divisional storage is possible. For example, in the present embodiment, file divisional storage as shown in FIG. 2 is realized by UDF. As shown in FIG. 5, the MO disk has a case 501 accommodating a disk 502. On the disk 502, a metadata storage area 503 is allocated for storing metadata by metadata area allocation processing to be described below, and the area is discriminated from a general area 504. Preferably the metadata storage area 503 is a continuous area. In a case where the storage area 503 is a continuous area, when metadata is referred to in search processing or the like, the processing can be made at a high speed. Further, as shown in FIG. 5, it is preferable that the metadata storage area 503 is allocated in the central portion of the disk 502 which can be accessed at a high speed. In this case, the speed of access to metadata is further improved.

(Metadata Allocation Processing)

Next, the metadata area allocation processing will be described. In UDF, a disk area of particular directory can be allocated in advance only for use of file under the directory. However, in the present embodiment, the metadata storage area is allocated by generating an “area file” having a file size of metadata storage area. The name of directory for which the metadata area is allocated is designated when the area is allocated by using the function of UDF. Accordingly, the metadata area is assigned to the directory at the same time when it is allocated. The allocation of metadata storage area is performed by the user's instruction after disk initialization. There is no problem if the area allocation is automatically performed after the initialization by using a specialized driver or the like. In this manner, the allocation of metadata storage area by generating an area file is effective in a file system which lacks means for allocating a disk area in advance. Note that in this case, the allocation of metadata storage area may be made within a directory for storing binary data, or in other directories than the above directory.

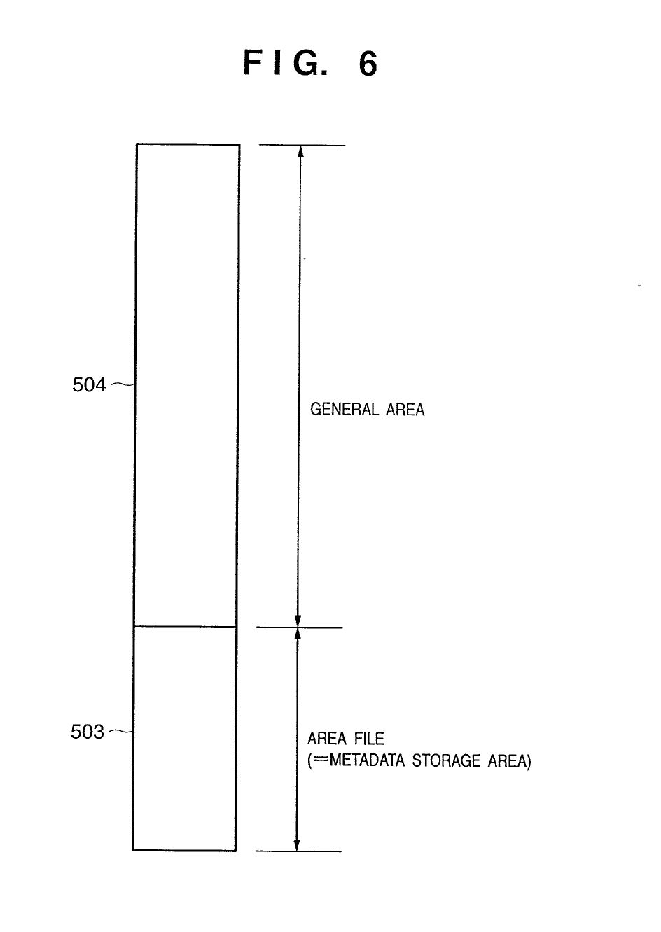

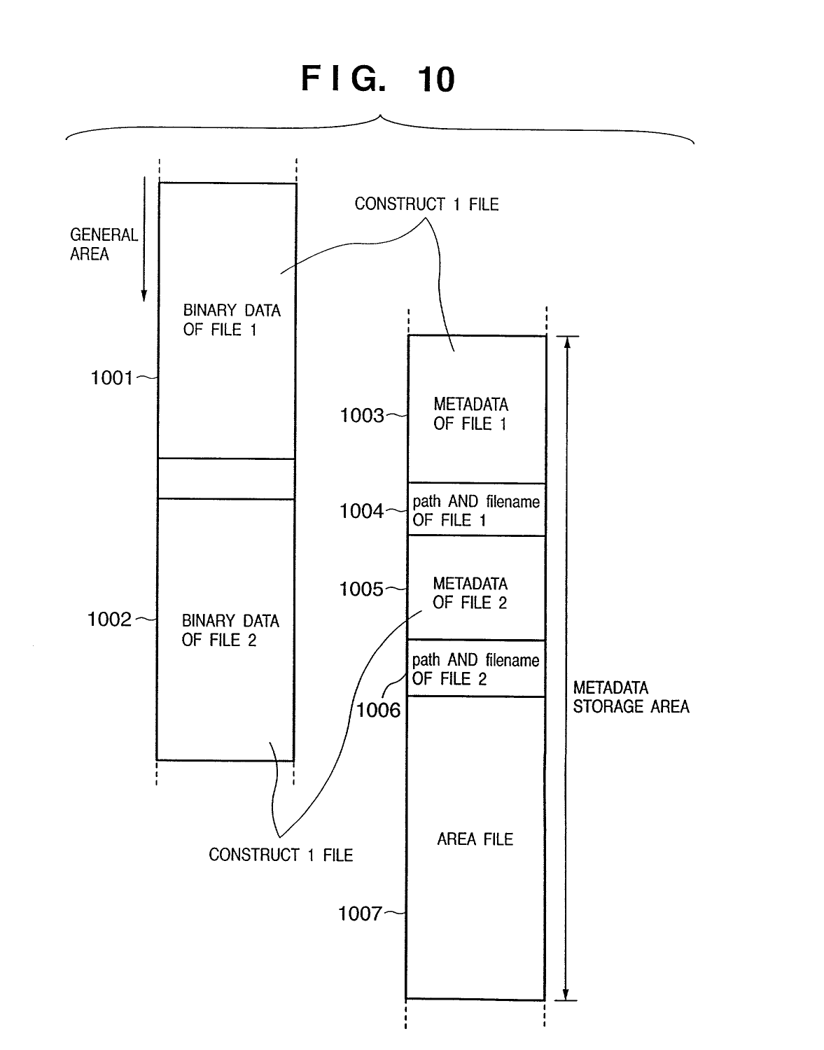

FIG. 6 is a schematic diagram showing the storage area of a disk when a metadata storage area is allocated by generating an area file. As shown in FIG. 6, the metadata area 503 is allocated by generating an area file having the size of metadata storage area on the disk. When metadata is stored by file storage processing to be described later, the size of the area file is reduced in correspondence with the amount of the metadata. That is, the sum of the size of stored metadata and the size of the area file is always equal to the size of metadata storage area 503 (See FIG. 10).

Note that it is desirable that the area file is prevented from being erroneously deleted by setting a file attribute to invisible or setting write protection.

(Processing to Save File Including Binary Data and Metadata)

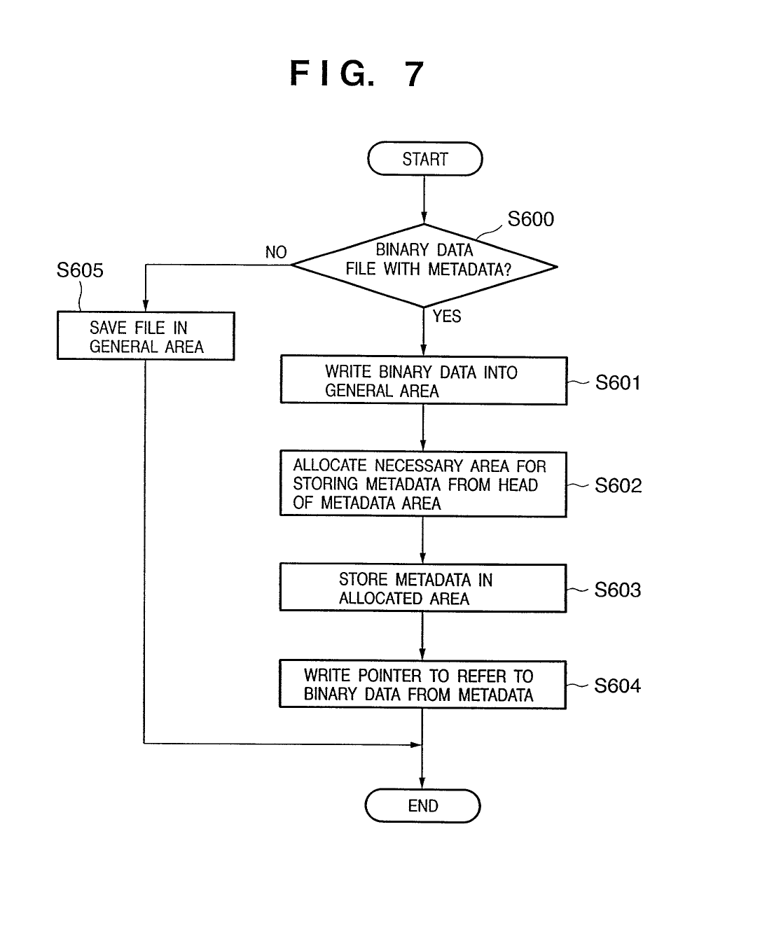

Next, a procedure for saving a file, having the structure as shown in FIG. 2, on a storage medium where the metadata storage area is allocated as above will be described. FIG. 7 is a flowchart showing file storage processing according to the first embodiment.

First, at step S600, it is determined whether or not a save subject file is a file including metadata and binary data. In the present embodiment, it is determined whether metadata is included in a file by extracting the last 8 bytes of the file and examining whether or not the 8bytes correspond with “</PHOTO>”. If the save subject file does not include metadata, the process proceeds to step S605, at which the file is saved in a general area, and the process ends. On the other hand, if the save subject file includes metadata and binary data, the process proceeds to step S601. At step S601, a part enclosed with tags “<PHOTO>” and “</PHOTO>” is separated as metadata, thereby the binary data is extracted from the save subject file and written into the general area 504.

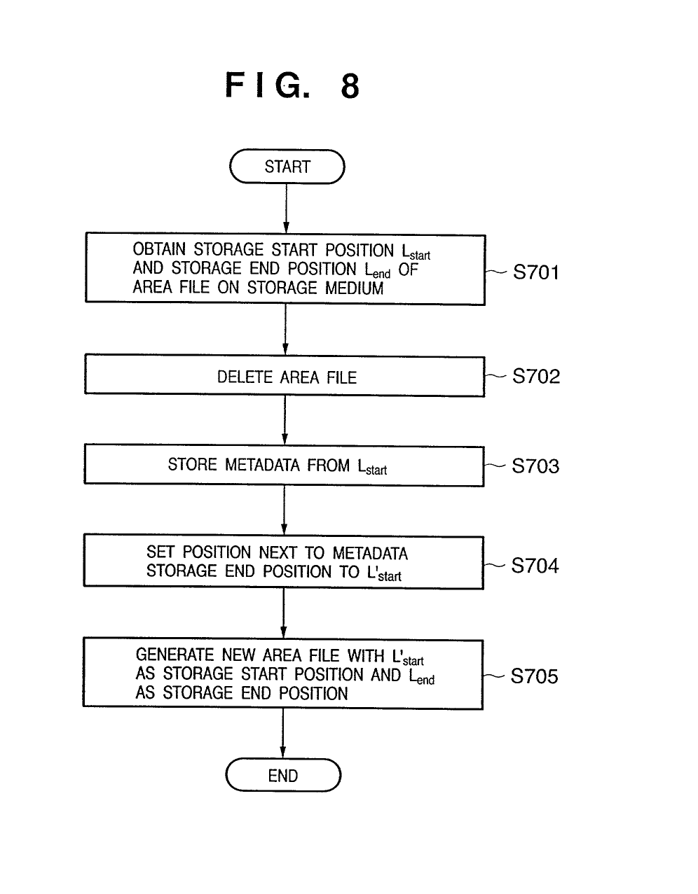

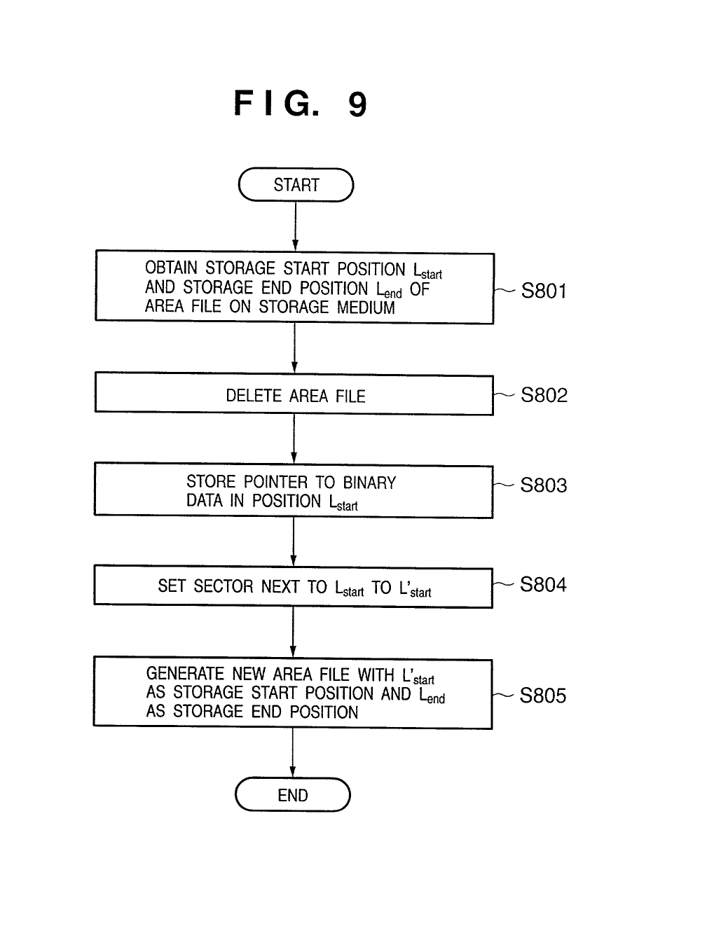

Next, at step S602, an area having a size necessary for storing the metadata (the above separated metadata) of the save subject file is allocated from the metadata storage area. In the present embodiment, a storage area necessary for each metadata is sequentially allocated from the head of the metadata storage area. At this time, the size of the area file is reduced in correspondence with a size used for storage of metadata. Then, at step S603, the metadata of the save subject file is written into the area allocated at step S602. Note that the details of the metadata storage processing at steps S602 and S603 will be described later with reference to the flowchart of FIG. 8. At step S604, a pointer to refer to the binary data from the metadata is set, and the process ends. Note that the processing at step S604 will be described later with reference to the flowchart of FIG. 9.

FIG. 8 is a flowchart showing processing to allocate an area for storing metadata from the metadata storage area and store the metadata in the area.

First, at step S701, a storage start position Lₛₜₐᵣₜ and a storage end position Lend of area file on the storage medium are obtained. In the present embodiment, the positions Lₛₜₐᵣₜand Lend are represented by sector number. Next, to use a part of the area file (a part from the header) for storing the metadata, the area file is deleted at step S702. Then at step S703, the metadata is stored from the storage start position Lₛₜₐᵣₜ on the storage medium, and the process proceeds to step S704. At step S704, a next sector number to the storage end position is obtained as L'start. At step S705, an area file is newly generated with the position L'ₛₜₐᵣₜ as the storage start position and the storage end position Lend, and the process ends.

By the above processing, the metadata is stored from the head of the area (corresponding to the metadata storage area 502 in the initial state) allocated by the area file, and the remaining area is newly allocated by the area file.

Next, processing to establish linkage between the binary data stored in the general area 504 and the metadata (step S604) will be described. FIG. 9 is a flowchart showing the processing to establish linkage between binary data and metadata. Note that both data can be linked with each other by storing information specifying the binary data in the metadata, however, in the present embodiment, information to link the metadata with the binary data (link information) is stored in 1-sector area (fixed length area) following the metadata within the metadata storage area. In the present embodiment, the link information is a pointer which represents binary data to be linked by using a path and a file name. Note that the link information is not limited to that in the present embodiment but may be a head number of sector holding binary data to be linked.

In a case where the metadata includes description of link information specifying its related binary data, such processing is unnecessary. However, if the link information is stored independently of the metadata as described above, linkage can be made in use of metadata which lacks description of link information, and the flexibility of the system can be improved.

At steps S801 and S802, as in the case of processing at steps S701 and S702, the storage start position Lₛₜₐᵣₜ and the storage end position Lend of area file are obtained and then the area file is deleted. Then at step S803, a pointer, i.e., a path and a file name of related binary data are stored in a sector designated by the position L_{start.}Then at step S804, the sector next to the position Lₛₜₐᵣₜ is set as L'start, and at step S805, as in the case of step S705, an area file is generated by the positions L'start and Lend, and the process ends.

In this manner, as link information to refer to binary data from metadata is added to the metadata, it is possible to read only the metadata storage area to perform a search and extract necessary binary data.

By the above-described processing, when one file including binary data and metadata is stored into a storage medium, the binary data can be stored into the general area 504 and the metadata, into the metadata storage area 503, respectively.

FIG. 10 is a schematic view explaining the status of file stored in the storage medium according to the first embodiment. FIG. 10 shows stored two files (file 1 and file 2) having binary data and metadata. As shown in FIG. 10, binary data 1001 of the file 1 and binary data 1002 of the file 2 are stored in the general area. Metadata 1003 of the file 1, a pointer (link information) 1004 from the metadata to the binary data in the file 1, metadata 1005 of the file 2, a pointer (link information) 1006 from the metadata to the binary data in the file 2, are stored in the metadata storage area. The remaining area is held as an area file 1007.

As described above, as metadata is stored in a continuous area on a recording medium, only the metadata can be read at a high speed. Further, as a pointer (link information) to binary data related to the metadata is stored with the metadata, even in a case where the metadata lacks description of link information (file name or the like), access to necessary binary data can be made.

Further, in an ordinary relational database, it is necessary to store a path of search subject file and its metadata into the database. In this case, upon movement and/or deletion of file, the content of the data base must be updated. On the other hand, according to the present embodiment, as metadata and binary data are stored in one file such that a search for the metadata attached to the binary data is made, the above-described processing upon file movement and/or deletion can be omitted.

Further, in the above embodiment, the link information is stored into the metadata storage area, however, it may be arranged such that all the link information are registered in a data base.

<Second Embodiment>

In the first embodiment, the method for high-speed access to metadata stored with binary data in one file has been described. As a second embodiment, a case where mutually related binary data and metadata are stored in different files will be described. Note that the system to realize data management described in the second embodiment has the same configuration as that of the first embodiment.

In some file systems, one file cannot be divisionally stored. In such case, when binary data and its metadata are stored as different files, to access the metadata at a high speed, the metadata file is written into the metadata storage area and the binary data file is written into the general area, in a similar method to that of the first embodiment.

Note that when the binary data and the metadata are stored in different files, the metadata file includes a pointer to the binary data to be referred to. Accordingly, it is not necessary to store a pointer to binary data in the metadata storage area as in the case of the first embodiment.

As described above, even in a case where binary data and metadata are stored in different files in a file system where one file cannot be divisionally stored, as only the metadata is written into a pre-provided continuous area, the metadata can be accessed at a high speed.

<Third Embodiment>

In the above respective embodiments, XML is used as metadata description format. As a metadata standard using XML, DIG35 is known. It is possible to apply the DIG35 standard to metadata description in the constructions described in the first and second embodiments.

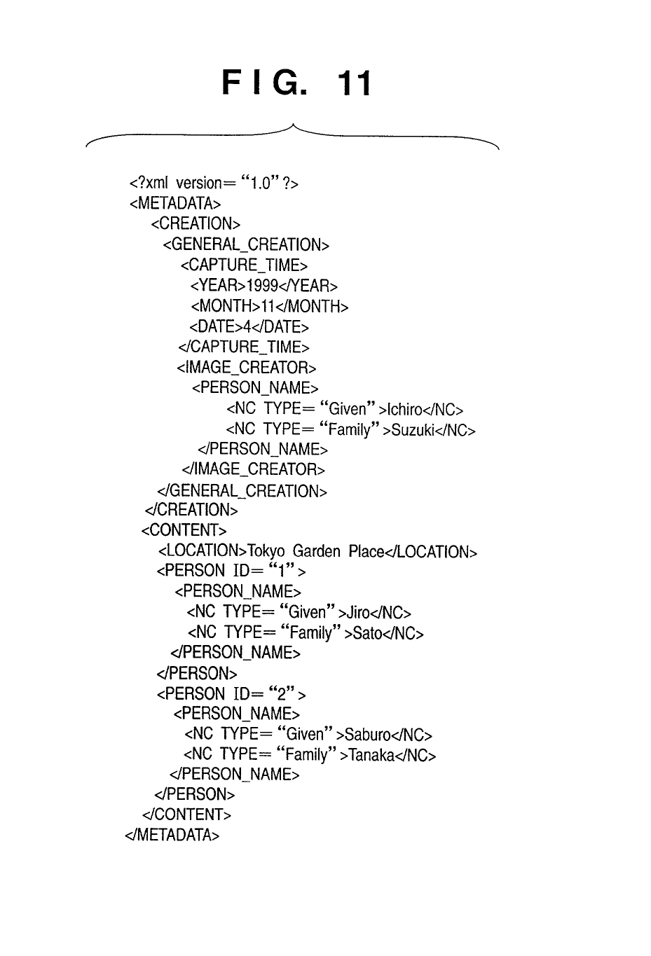

The DIG35 standard is used for standardization of item and description method of still image metadata, and is characterized in that XML is used for describing metadata. FIG. 11 is an example of the content of metadata in FIG. 3 described in conformance with the DIG35 standard. First, a tag representing the start of metadata based on the DIG35 standard is described. For example, in the present embodiment, as shown in FIG. 11, described data enclosed with a start tag <METADATA> and an end tag </METADATA> can be determined as metadata. In this manner, as metadata is described in a predetermined structure using XML, environment-independent and highly-flexible data description can be made.

The construction to save a binary file including metadata described based on the above DIG35 standard is as described in the first embodiment, therefore the explanation of the construction will be omitted, and a part different from the first embodiment will be described.

First, in a case where metadata in conformity with the DIG35 standard is used, the tags <METADATA> and </METADATA> are used in place of the tags <PHOTO> and </PHOTO> in the file storage processing in FIG. 7. That is, when it is determined at step S600 whether or not the save subject file includes metadata and binary data, the last 11 bytes of the file are extracted and it is examined whether or not the 11 bytes correspond with “</METADATA>”. If the save subject file includes metadata and binary data, the process proceeds to step S601, at which metadata enclosed with the tags <METADATA> and </METADATA> is separated from the save subject file, thereby the binary data is extracted and written into the general area 504.

In the constructions described in the first and second embodiments, metadata in conformance with the DIG35 standard can be handled by the above change.

As described above, according to the above respective embodiments, metadata is stored in a pre-allocated specialized area, thereby the metadata can be accessed at a high speed. Further, as link information to binary data is included on the metadata side, binary data related to the metadata can be easily extracted.

Note that in the above respective embodiments, binary data is still image data, however, the binary data is not limited to still image data. For example, as binary data, video data, sound data, music data and the like may be handled.

Further, in the above first embodiment, XML is used for description of metadata, however, other data description languages such as HTML (Hypertext Markup Language) and SGML (Standard Generalized Markup Language) may be used, and further, TIFF tags may be used.

Further, in the above respective embodiments, a magneto-optic disk is used as the storage medium corresponding of the recording unit 108, however, the storage medium is not limited to the magneto-optic disk. For example, a floppy disk, a memory card, a hard disk and the like may be used as the storage medium of the recording unit 108.

Further, in the above first embodiment, one file where binary data and metadata are described is saved, and in the second embodiment, different files where binary data and metadata are respectively described are saved, however, it may be arranged such that one of processings described in the first and second embodiments is selected in accordance with type of save subject file. For example, as described in the first embodiment, it can be determined whether or not binary data and metadata are described in one file by extracting the last 8 bytes of file and examining whether or not the 8 bytes correspond with “</PHOTO>”. If it is determined that binary data and metadata are described in one file, the processing in the first embodiment is performed, otherwise, the processing in the second embodiment is performed. In this case, various file formats can be handled in a flexible manner.

The present invention can be applied to a system constituted by a plurality of devices (e.g., a host computer, an interface, a reader and a printer) or to an apparatus comprising a single device (e.g., a copy machine or a facsimile apparatus).

Further, the object of the present invention can be also achieved by providing a storage medium (or recording medium) storing software program code for performing the aforesaid processes to a system or an apparatus, reading the program code with a computer (e.g., CPU, MPU) of the system or apparatus from the storage medium, then executing the program.

In this case, the program code read from the storage medium realizes the functions according to the embodiments, and the storage medium storing the program code constitutes the invention.

Further, the storage medium, such as a floppy disk, a hard disk, an optical disk, a magneto-optical disk, a CD-ROM, a CD-R, a DVD, a magnetic tape, a non-volatile type memory card, and ROM can be used for providing the program code.

Furthermore, besides aforesaid functions according to the above embodiments are realized by executing the program code which is read by a computer, the present invention includes a case where an OS (operating system) or the like working on the computer performs a part or entire processes in accordance with designations of the program code and realizes functions according to the above embodiments.

Furthermore, the present invention also includes a case where, after the program code read from the storage medium is written in a function expansion card which is inserted into the computer or in a memory provided in a function expansion unit which is connected to the computer, CPU or the like contained in the function expansion card or unit performs a part or entire process in accordance with designations of the program code and realizes functions of the above embodiments.

As described above, according to the present invention, metadata of binary data as a search subject can be accessed at a high speed.

As many apparently widely different embodiments of the present invention can be made without departing from the spirit and scope thereof, it is to be understood that the invention is not limited to the specific embodiments thereof except as defined in the appended claims.

What is claimed is:

1. An information processing method for storing binary data and metadata related to the binary data into a storage medium, comprising:
an allocation step of allocating a first storage area for metadata in advance on said storage medium;
a first storage step of allocating a metadata storage area for storing said metadata from said first storage area allocated at said allocation step, and storing said metadata into said metadata storage area;
a second storage step of storing binary data related to said metadata into a second storage area other than said first storage area on said storage medium; and
a third storage step of storing link information that links said metadata stored in said first storage area with said binary data stored in said second storage area, in correspondence with said metadata, into said first storage area,
wherein at third storage step, said link information is stored into an area adjacent to an area where said metadata is stored.

2. The method according to claim 1, wherein said adjacent area is a sector next to the area where said metadata is stored.

3. The method according to claim 1, wherein at said third storage step, an adjacent area having a fixed length is allocated, and said link information is stored in the area.

4. The method according to claim 1, wherein said link information is described as a path and a file name of said binary data.

5. The method according to claim 1, wherein said link information is a head sector number of an area where said binary data is stored.

6. The method according to claim 1, further comprising a registration step of registering link information, that links said metadata stored in said first storage area with said binary data stored in said second storage area, in a database.

7. The method according to claim 1, wherein said metadata and said binary data are managed as one file.

8. The method according to claim 1, wherein said metadata and said binary data are managed as different files.

9. The method according to claim 1, wherein at said allocation step, said metadata storage area is allocated in a portion in said storage medium that can be accessed at a high speed.

10. The method according to claim 9, wherein said storage medium is a magneto-optic disk, and wherein an inner radial side of said magneto-optic disk is allocated as said metadata storage area.

11. The method according to claim 1, wherein at said allocation step, said metadata storage area is allocated by generating an area file having a size the same as that of said metadata storage area and holding the file on said storage medium.

12. The method according to claim 11, wherein at said first storage step, said area file is deleted, then said metadata is stored from a start position of an area where said file has been stored, and a remaining area of said metadata storage area following storage of said metadata is held again as an area file.

13. The method according to claim 1, wherein at said allocation step, said first storage area is allocated in a directory where said binary data is stored.

14. The method according to claim 1, wherein at said allocation step, said first storage area is allocated in a directory different from a directory where said binary data is stored.

15. The method according to claim 13, wherein at said first storage step, an area necessary for storing each metadata is located in the first storage area allocated at said allocation step.

16. The method according to claim 1, wherein said metadata includes description of information specifying related binary data.

17. The method according to claim 1, wherein said metadata is described in a predetermined data description language.

18. The method according to claim 17, wherein said predetermined data description language is any one of XML (Extensible Markup Language), SGML (Standard Generalized Markup Language) and TIFF (Tagged Image File Format).

19. The method according to claim 1, wherein said metadata abides by the DIG35 standard.

20. The method according to claim 1, wherein said binary data is at least one of still image data, video data, sound data and music data.

21. The method according to claim 1, wherein said storage medium is any one of a magneto-optic disk, a floppy disk, a memory card and a hard disk.

22. An information processing apparatus for storing binary data and metadata related to the binary data into a storage medium, comprising:
allocation means for allocating a first storage area for metadata in advance on said storage medium;
first storage means for allocating a metadata storage area for storing said metadata from said first storage area allocated by said allocation means, and storing said metadata into said metadata storage area;
second storage means storing binary data related to said metadata into a second storage area other than said first storage area on said storage medium; and
third storage means for storing link information that links said metadata stored in said first storage area with said binary data stored in said second storage area, in correspondence with said metadata, into said first storage area,
wherein said third storage means stores said link information into an area adjacent to an area where said metadata is stored.

23. The apparatus according to claim 22, wherein said adjacent area is a sector next to the area where said metadata is stored.

24. The apparatus according to claim 22, wherein said third storage means allocates an adjacent area having a fixed length, and stores said link information in the area.

25. The apparatus according to claim 22, wherein said link information is described as a path and a file name of said binary data.

26. The apparatus according to claim 22, wherein said link information is a head sector number of an area where said binary data is stored.

27. The apparatus according to claim 22, further comprising registration means for registering link information, that links said metadata stored in said first storage area with said binary data stored in said second storage area, in a database.

28. The apparatus according to claim 22, wherein said metadata and said binary data are managed as one file.

29. The apparatus according to claim 22, wherein said metadata and said binary data are managed as different files.

30. The apparatus according to claim 22, wherein said allocation means allocates said metadata storage area in a portion in said storage medium that can be accessed at a high speed.

31. The apparatus according to claim 30, wherein said storage medium is a magneto-optic disk, and wherein an inner radial side of said magneto-optic disk is allocated as said metadata storage area.

32. The apparatus according to claim 22, wherein said allocation means allocates said metadata storage area by generating an area file having a size the same as that of said metadata storage area and holding the file on said storage medium.

33. The apparatus according to claim 32, wherein said first storage means deletes said area file, then stores said metadata from a start position of an area where said file has been stored, and again holds a remaining area of said metadata storage area following storage of said metadata as an area file.

34. The apparatus according to claim 22, wherein said allocation means allocates said first storage area in a directory where said binary data is stored.

35. The apparatus according to claim 22, wherein said allocation means allocates said first storage area in a directory different from a directory where said binary data is stored.

36. The apparatus according to claim 34, wherein said first storage means allocates an area necessary for storage to each metadata in the first storage area allocated by said allocation means.

37. The apparatus according to claim 22, wherein said metadata includes description of information specifying related binary data.

38. The apparatus according to claim 22, wherein said metadata is described in a predetermined data description language.

39. A control program for a computer to execute an information processing method for storing binary data and metadata related to the binary data into a storage medium, wherein said information processing method comprising:
an allocation step of allocating a first storage area for metadata in advance on said storage medium;
a first storage step of allocating a metadata storage area for storing said metadata from said first storage area allocated at said allocation step, and storing said metadata into said metadata storage area;
a second storage step of storing binary data related to said metadata into a second storage area other than said first storage area on said storage medium; and
a third storage step of storing link information that links said metadata stored in said first storage area with said binary data stored in said second storage area, in correspondence with said metadata, into said first storage area,
wherein at third storage step, said link information is stored into an area adjacent to an area where said metadata is stored.

40. A storage medium holding a control program for a computer to execute an information processing method for storing binary data and metadata related to the binary data into a storage medium, wherein said information processing method comprising:
an allocation step of allocating a first storage area for metadata in advance on said storage medium;
a first storage step of allocating a metadata storage area for storing said metadata from said first storage area allocated at said allocation step, and storing said metadata into said metadata storage area;
a second storage step of storing binary data related to said metadata into a second storage area other than said first storage area on said storage medium; and
a third storage step of storing link information that links said metadata stored in said first storage area with said binary data stored in said second storage area, in correspondence with said metadata, into said first storage area,
wherein at third storage step, said link information is stored into an area adjacent to an area where said metadata is stored.
